(19) United States
(12) Patent Application Publication
(10) Pub. No.: US 2022/0239482 A1
(43) Pub. Date: Jul. 28, 2022

(54) METHOD FOR VERIFYING ACTIVITY INFORMATION BY MEANS OF BLOCKCHAIN

(71) Applicant: MTS COMPANY CO., LTD., Seoul (KR)

(72) Inventors: Hee-Won CHUNG, Gyeonggi-do (KR); Sung-Yeol LEE, Seoul (KR)

(21) Appl. No.: 17/615,237

(22) PCT Filed: May 27, 2020
(86) PCT No.: PCT/KR2020/006841

§ 371 Date: Nov. 30, 2021

(30) Foreign Application Priority Data
May 31, 2019 (KR) 10-2019-0064372

(51) Int. Cl. H04L 9/32; H04L 9/00

(52) U.S. Cl. CPC H04L 9/32; H04L 9/50

(57) ABSTRACT

In a method of verifying activity information by a blockchain according to an embodiment of the present disclosure, when validity of specific activity information of a specific node is verified, a consensus algorithm for verifying validity based on previous activity information, instead of a standardized consensus algorithm, is applied to verify the validity in a variable way.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2020/006841, filed May 27, 2020, which claims priority to the benefit of Korean Patent Application No. 10-2019-0064372 filed in the Korean Intellectual Property Office on May 31, 2019, the entire contents of which are incorporated herein by reference.

### BACKGROUND

### 1. Technical Field

The present disclosure relates to a method of verifying activity information by means of a blockchain.

### 2. Background Art

A blockchain has a function of a transaction ledger that continuously records transactions of virtual currency exchanged between nodes in a decentralized virtual currency transaction system such as Bitcoin.

The reason why a blockchain functioning as a transaction ledger is needed in a decentralized virtual currency transaction system is that virtual currency does not exist as real physical currency, but only exists virtually.

That is, although 100 won generated as virtual currency for the first time always exists conceptually in total within a system over time, the 100 won may exist by being divided 100 times and included as 1 won in each of 100 electronic wallets respectively located in 100 nodes within the system, or the 100 won may exist by being combined with 200 won, which is another virtual currency, and included in 300 won in a wallet of a specific node.

Accordingly, data for determining whether virtual currency that is currently traded has legitimacy may be a transaction history from a time when the virtual currency was first generated to a present time, and the transaction history should be traced back to determine whether the virtual currency has consistent legitimacy from the time when the virtual currency was generated to the present time.

When a central server such as a bank manages virtual currency collectively, the central server collectively records virtual currency transaction details. However, in the case of a blockchain, transaction details are recorded by nodes within a decentralized system consisting of decentralized nodes. Accordingly, whenever the blockchain is traded, transaction details are encrypted to create a block, and the newly created block is combined with the blockchain to update a transaction ledger.

The strength of cryptography for a blockchain is that details recorded whenever a transaction occurs from the past to the present are linked together by using a hash value.

Accordingly, it is impossible to manipulate transaction details unless all transactions within a transaction system, rather than one specific hash value, are decrypted. Also, because transactions that occur every moment are created as a block and combined with a blockchain, and a ledger of the transactions exists in multiple nodes in a distributed manner, it is impossible to decrypt the entire blockchain or hack the blockchain-based virtual currency transaction system even if it takes hundreds of years with modern computers.

That is, the legitimacy of blockchain-based virtual currency may be verified through transaction details described in an existing blockchain, and the virtual currency may have reliability because the transaction details may not be manipulated in reality.

Accordingly, in a virtual currency transaction system using a blockchain, transactions made from moment to moment are propagated to all nodes and encrypted to newly create transaction records as a block, and the new block is combined with the blockchain continuously.

As such, a process of grouping new transaction details together to create one new block for a certain period (e.g., 1 minute, 3 minutes, or 10 minutes) and, when the block has legitimacy, connecting the block to an existing blockchain is called “proof of work”.

As blockchain technology develops, there is a need to develop a new consensus algorithm for variably verifying the validity of each activity, in addition to such a standardized consensus method.

### SUMMARY

The technical problem to be solved by the present disclosure is to provide a method of verifying activity information by means of a blockchain which, during verification of validity of specific activity information of a specific node, may apply a consensus algorithm for verifying validity based on previous activity information, instead of a standardized consensus algorithm, to verify the validity in a variable way.

Objectives of the present disclosure are not limited thereto, and other objectives not mentioned will be clearly understood by one of ordinary skill in the art from the following description.

According to an embodiment of the present disclosure for solving the technical problem, a method of verifying activity information by means of a blockchain includes: (a), for k^{th} activity information H_k (k is a natural number equal to or greater than 2) of any one node N_a (a is a natural number equal to or less than n) from among n nodes N_n (n is a natural number), allowing other nodes to verify validity by using a consensus algorithm CA; and (b), when it is verified that the k^{th} activity information H_k is valid, generating the k^{th} activity information H_k as a block B and storing the generated block B in a blockchain BC.

Also, in operation (a), when validity of k^{th} activity information H_k is verified, the consensus algorithm CA may use total activity information

$$( {\sum }_{n = 1}^{k - 1} {H}_{n} )$$

up to k−1^{th} activity information H_k−1.

Also, in operation (a), some or all of the consensus algorithms CA may be different according to nodes.

Also, in operation (a), the consensus algorithm CA may be equally applied to nodes grouped according to a preset condition from among the n nodes N_n.

Also, in operation (a), when validity of the k^{th} activity information H_k is verified, the consensus algorithm CA may use total activity information)

$$( {\sum }_{n = 1}^{m} {H}_{n} )$$

up to m^{th} activity information H_m (m is a natural number equal to or less than k−1) selected from among activity information that is equal to or less than k−1th activity information H_k−1.

According to an embodiment of the present disclosure, during verification of validity of specific activity information of a specific node, a consensus algorithm for verifying validity based on previous activity information, instead of a standardized consensus algorithm, is applied to verify the validity in a variable way.

### BRIEF DESCRIPTION OF THE DRAWINGS

FIG. 1 is a diagram illustrating a method of verifying activity information by means of a blockchain, according to an embodiment of the present disclosure.

FIG. 2 is a diagram illustrating an example of block generation using a consensus algorithm, in a method of verifying activity information by means of a blockchain, according to another embodiment of the present disclosure.

FIG. 3 is a diagram illustrating an example where some or all of consensus algorithms are different according to nodes, in a method of verifying activity information by means of a blockchain, according to another embodiment of the present disclosure.

FIG. 4 is a diagram illustrating an example of a consensus algorithm applied to nodes grouped according to a preset condition, in a method of verifying activity information by means of a blockchain, according to another embodiment of the present disclosure.

FIG. 5 is a diagram illustrating an example of block generation using a consensus algorithm, in a method of verifying activity information by means of a blockchain, according to another embodiment of the present disclosure.

### DETAILED DESCRIPTION

Hereinafter, some embodiments of the present disclosure will be described in detail through exemplary drawings. In adding reference numerals to elements of each drawing, it should be noted that the same elements are denoted by the same reference numerals as much as possible even when they are indicated on different drawings. Also, in describing the present disclosure, detailed descriptions of related well-known functions or configurations that may blur the points of the present disclosure are omitted.

Also, in describing constituent elements of the present disclosure, the terms such as first, second, A, B, (a), and (b) may be used. These terms are intended to distinguish one element from another element, and only the essence, order, or sequence of the element is not limited thereto. It will be understood that when an element is referred to as being “connected”, “coupled”, or “accessed” to or by another element, the element may be directly connected, coupled, or accessed to or by the other element or intervening elements may be present.

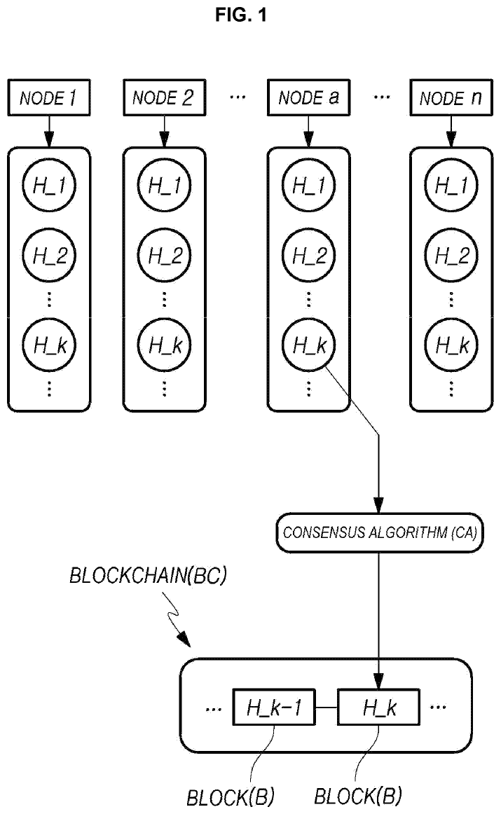

FIG. 1 is a diagram illustrating a method of verifying activity information by means of a blockchain, according to an embodiment of the present disclosure.

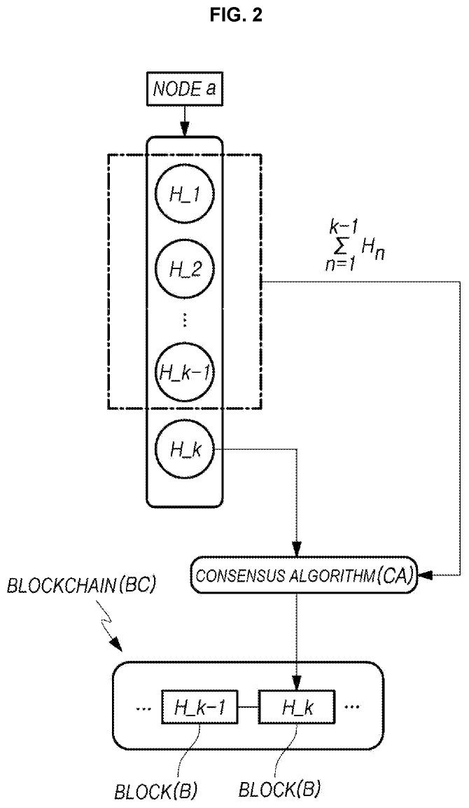

FIG. 2 is a diagram illustrating an example of block generation using a consensus algorithm, in a method of verifying activity information by means of a blockchain, according to another embodiment of the present disclosure.

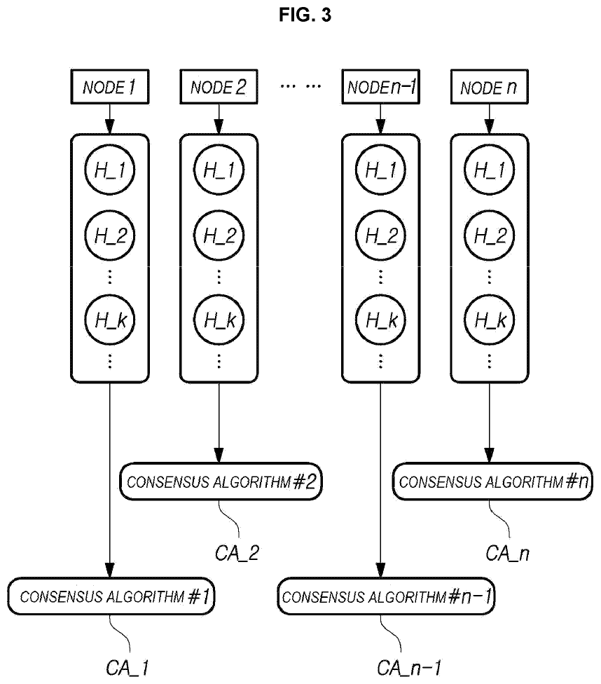

FIG. 3 is a diagram illustrating an example where some or all of consensus algorithms are different according to nodes, in a method of verifying activity information by means of a blockchain, according to another embodiment of the present disclosure.

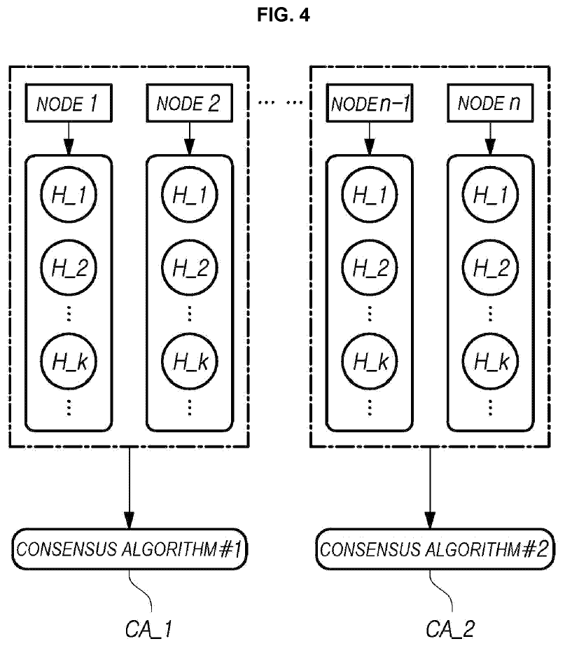

FIG. 4 is a diagram illustrating an example of a consensus algorithm applied to nodes grouped according to a preset condition, in a method of verifying activity information by means of a blockchain, according to another embodiment of the present disclosure.

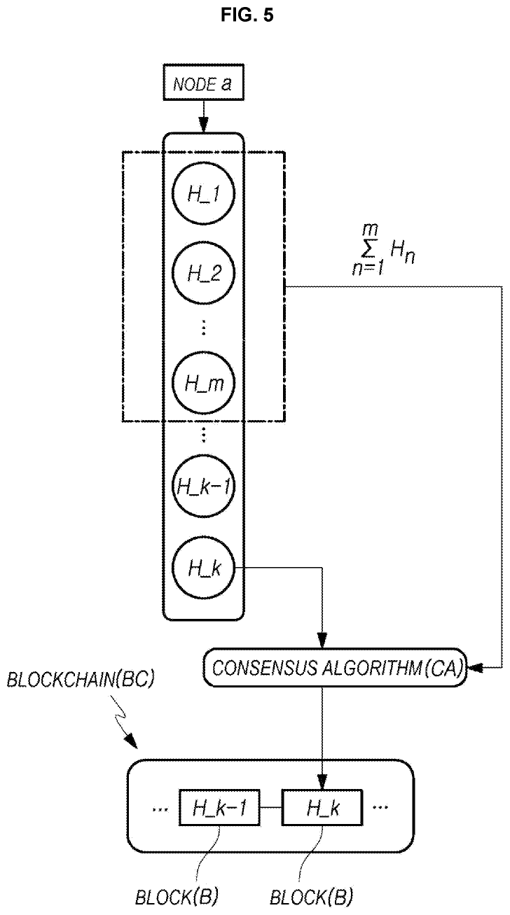

FIG. 5 is a diagram illustrating an example of block generation using a consensus algorithm, in a method of verifying activity information by means of a blockchain, according to another embodiment of the present disclosure.

As shown in the drawings, a method of verifying activity information by means of a blockchain according to an embodiment of the present disclosure includes: (a), for k^{th} activity information H_k (k is a natural number equal to or greater than 2) of any one node N_a (a is a natural number equal to or less than n) from among n nodes N_n (n is a natural number), allowing other nodes to verify validity by using a consensus algorithm CA; and (b), when it is verified that the k^{th} activity information H_k is valid, generating the k^{th} activity information H_k as a block B and storing the generated block B in a blockchain BC.

Hereinafter, each operation will be described in detail.

First, operation (a) is an operation in which, for k^{th} activity information H_k (k is a natural number equal to or greater than 2) of any one node N_a (a is a natural number equal to or less than n) from among n nodes (n is a natural number), other nodes verify validity using a consensus algorithm CA.

Here, the n nodes (n is a natural number) are defined as multiple nodes which are authorized to participate in a blockchain network and create a block.

The consensus algorithm CA is defined as a protocol (white paper or rules) agreed among other nodes to verify validity of the k^{th} activity information H_k (k is a natural number equal to or greater than 2) of the node N_a (a is a natural number equal to or less than n).

During verification of validity of the k^{th} activity information H_k of the node N_a, the consensus algorithm CA uses total activity information

$$( {\sum }_{n = 1}^{k - 1} {H}_{n} )$$

up to k−1^{th} activity information H_k−1.

For example, in the case that it is determined that first activity information H_1 of the node N_a is not valid and second activity information H_2 is also not valid, but third activity information H_3 is valid, when determining validity of fourth activity information H_4, the consensus algorithm CA may be set to recognize validity of the fourth activity information H_4, based on the validity of the third activity information H_3, by using information

$$( {{\sum }^{3}}_{n = 1} {H}_{n} )$$

of the first activity information H_1, the second activity information H_2, and the third activity information H_3.

Also, in the case that it is determined that the first activity information H_1 of the node N_a is not valid, the second activity information H_2 is not valid, but the third activity information H_3 is valid, when determining validity of the fourth activity information H_4, the consensus algorithm CA may be set to recognize validity of the fourth activity information H_4 because there exists the valid third activity information H_3 in the information

$$( {\sum }_{n = 1}^{3} {H}_{n} )$$

from the first activity information H_1 to the third activity information H_3.

As such, in an embodiment of the present disclosure, the consensus algorithm CA may vary according to how each node makes an agreement, and validity of activity information of a specific node may accordingly vary.

The above-described consensus algorithm CA may be equally applied to each node.

That is, when verifying validity of activity information of each node, such as activity information of a node 1 N_1, activity information of a node 2 N_2, and activity information of a node 3 N_3, the consensus algorithm CA may be equally applied.

According to another embodiment of the present disclosure, some or all of the consensus algorithms CA may be different according to nodes.

In more detail, as shown in FIG. 3, a consensus algorithm CA_1 for verifying validity of the k^{th} activity information H_k of the node 1 N_1, a consensus activity CA_2 for verifying validity of the k^{th} activity information H_k of the node 2 N_2, a consensus algorithm CA_n−1 for verifying validity of the k^{th} activity information H_k of a node n−1 N_n−1, and a consensus algorithm CA_n for verifying validity of the k^{th} activity information H_k of a node n N_n may be different from one another.

In contrast, for example, consensus algorithms from the consensus algorithm CA_1 for verifying validity of the k^{th} activity information H_k of the node 1 N_1 to the consensus algorithm CA_n−1 for verifying validity of the k^{th} activity information H_k of the node n−1 N_n−1 may be the same, and the consensus algorithm CA_n for verifying validity of the k^{th} activity information H_k of the node n N_n may be different.

According to another embodiment of the present disclosure, the consensus algorithm CA may be equally applied to nodes grouped according to a preset condition from among the n nodes N_n.

In FIG. 4, validity of the activity information H_k of the node 1 N_1 and the node 2 N_2 is verified by the same consensus algorithm CA_1, and validity of the activity information H_k of the node n−1 N_n−1 and the node n N_n is verified by the same consensus algorithm CA_2.

For example, when some or all of the n nodes (N_n) are grouped according to a preset condition, validity of the grouping may be determined according to the majority rule. Alternatively, when more than ⅔ of all nodes agree, validity of the grouping may be recognized.

Also, the ‘preset condition’ may be, for example, a condition according to whether or not the same or similar activity information H_k is present.

According to another embodiment of the present disclosure, during verification of validity of the k^{th} activity information H_k, the consensus algorithm CA uses total activity information

$${\sum }_{n = 1}^{m} {H}_{n}$$

up to m^{th} activity information H_m (m is a natural number equal to or less than k−1) from among activity information that is equal to or less than the k−1^{th} activity information H_k−1.

For example, in the case that it is determined that the first activity information H_1 of the node N_a is not valid, the second activity information H_2 is also not valid, the third activity information H_3 through the fifth activity information H_5 are valid, and the sixth activity information H_6 is not valid, when validity of the seventh activity information H_7 is verified, the consensus algorithm CA may be set to recognize validity of the seventh activity information H_7, based on the validity of the third activity information H_3, by using total activity information

$${\sum }_{n = 1}^{3} {H}_{n}$$

up to the third activity information H_3 selected from among the activity information H_1 through H_6 that is equal to or less than the sixth activity information H_6.

Subsequently, operation (b) is an operation in which, when it is verified that the k^{th} activity information H_k is valid, the k^{th} activity information H_k is generated as a block B, and the generated block B is stored in a blockchain BC.

Here, the blockchain BC is a ‘decentralized data storage’ for transparently recording all transaction details and simultaneously copying and storing them in numerous computers, and refers to ‘blocks’ that contain data and are linked together to form a ‘chain’.

When it is verified that the k^{th} activity information H_k is not valid, the k^{th} activity information H_k is not generated as a block B.

As described above, according to an embodiment of the present disclosure, during verification of validity of specific activity information of a specific node, a consensus algorithm for verifying validity based on previous activity information, instead of a standardized consensus algorithm, is applied to verify the validity in a variable way.

In the above, even when all constituent elements constituting the embodiments of the present disclosure have been described as being combined into one or operating in combination, the present disclosure is not necessarily limited thereto. That is, within the scope of the objectives of the present disclosure, all of the constituent elements may operate by being combined into one or more.

The above description is merely illustrative of the technical idea of the present disclosure, and one of ordinary skill in the art to which the present disclosure pertains will be able to make various modifications and variations without departing from the essential characteristics of the present disclosure. Accordingly, the embodiments of the present disclosure should be considered in descriptive sense only and not for purposes of limitation of the scope of the present disclosure. The scope of the present disclosure is defined not by the detailed description of the present disclosure but by the appended claims, and all differences within the scope will be construed as being included in the present disclosure.

1. A method of verifying activity information by a blockchain, the method comprising: (a), for k^{th} activity information H_k (k is a natural number equal to or greater than 2) of any one node N_a (a is a natural number equal to or less than n) from among n nodes N_n (n is a natural number), allowing other nodes to verify validity by using a consensus algorithm CA; and
(b), when it is verified that the k^{th} activity information H_k is valid, generating the k^{th} activity information H_k as a block B and storing the generated block B in a blockchain BC.

2. The method of claim 1, wherein, in operation (a), when validity of k^{th} activity information H_k is verified, the consensus algorithm CA uses total activity information
$$( {\sum }_{n = 1}^{k - 1} {H}_{n} )$$
up to k−1^{th} activity information H_k−1.

3. The method of claim 1, wherein, in operation (a), at least a part of the consensus algorithms CA are different according to nodes.

4. The method of claim 1, wherein, in operation (a), the consensus algorithm CA is equally applied to nodes grouped according to a preset condition from among the n nodes N_n.

5. The method of claim 1, wherein, in operation (a), when validity of the k^{th} activity information H_k is verified, the consensus algorithm CA uses total activity information
$$( {\sum }_{n = 1}^{m} {H}_{n} )$$
up to m^{th} activity information H_m (m is a natural number equal to or less than k−1) selected from among activity information that is equal to or less than k−1^{th} activity information H_k−1.
